(19) United States
(12) Patent Application Publication
(10) Pub. No.: US 2024/0403406 A1
(43) Pub. Date: Dec. 5, 2024

(54) VEHICLE OVER-THE-AIR UPDATE AUTHENTICATION SYSTEM AND METHOD

(71) Applicant: FCA US LLC, Auburn Hills, MI (US)

(72) Inventors: Vinoot Handiganoor, Bangalore (IN); Priyanka Arudra, Telangana (IN); Banuprakash Kuntanahalli, Bangalore (IN); Ajwad Ishaque, Windsor (CA)

(21) Appl. No.: 18/325,639

(22) Filed: May 30, 2023

(51) Int. Cl. G06F 21/44; G06F 8/65; G06F 21/57

(52) U.S. Cl. CPC G06F 21/44; G06F 8/65; G06F 21/572; G06F 2221/033

(57) ABSTRACT

A vehicle with an over-the-air (OTA) software update and authentication system includes a vehicle computing device, including one or more processors, a communication device for communication with a secure server via a network, and a non-transitory computer-readable storage medium. The one or more processors are configured to receive and install an OTA software update stored in the secure server, the stored OTA software update having an associated first checksum value, receive a request to authenticate the installed OTA software update, the installed OTA software update having an associated second checksum value, send a signal to the secure server representing the second checksum value to be compared, by the secure server, with the first checksum value, receive, from the secure server, a signal indicating if the compared first and second checksum values match or do not match, and determining the installed OTA software update is authenticated based on the signal.

### FIELD

The present application relates generally to vehicles equipped with systems to receive software updates and, more particularly, to systems and methods to authenticate over-the-air vehicle software updates.

### BACKGROUND

Many vehicles are equipped with infotainment or multimedia systems that require software updates to maintain or improve the systems. However, unsecured updates are potentially vulnerable to unintended users and may be compromised. This may potentially result in additional cost and effort to resolve such compromised software updates. Accordingly, while such over-the-air vehicle software update systems do work for their intended purpose, there is a desire for improvement in the relevant art.

### SUMMARY

In accordance with one example aspect of the invention, a vehicle with an over-the-air (OTA) software update and authentication system is provided. In one example, the system includes a vehicle computing device, including one or more processors, a communication device for communication with a secure server via a network, and a non-transitory computer-readable storage medium having a plurality of instructions stored thereon, which, when executed by the one or more processors, cause the one or more processors to perform operations including: receive and install an OTA software update stored in the secure server, the stored OTA software update having an associated first checksum value, receive a request to authenticate the installed OTA software update, the installed OTA software update having an associated second checksum value, send a signal to the secure server representing the second checksum value to be compared, by one or more processors of the secure server, with the first checksum value, receive, from the secure server, a signal indicating if the compared first and second checksum values match or do not match, determining the installed OTA software update is authenticated if the received signal indicates the compared first and second checksum values match, and determining the installed OTA software update authentication is failed if the received signal indicates the compared first and second checksum values do not match.

In addition to the foregoing, the described system may include one or more of the following features: wherein when the compared first and second checksum values do not match, the computing device rolls back the installed OTA software update to a previous version of the OTA software update; wherein when the compared first and second checksum values do not match, the vehicle computing device receives and reinstalls the OTA software update stored in the secure server; and wherein after installing the OTA software update, the computing device provides a vehicle user with an option to authenticate the installed OTA software update.

In addition to the foregoing, the described system may include one or more of the following features: wherein the received request to authenticate the installed OTA software update is received from the vehicle user via the provided option; wherein the option to authenticate the installed OTA software update is displayed on a vehicle display; and wherein the option to authenticate the installed OTA software update is displayed on a portable electronic device associated with the vehicle user.

In accordance with another example aspect of the invention, a computer-implemented method for authenticating an over-the-air (OTA) software update for a vehicle is provided. In one example, the method includes receiving, at a vehicle computing device having one or more processors, an OTA software update stored in a secure server, the stored OTA software update having an associated first checksum value; installing, with the vehicle computing device, the received OTA software update; receiving, via the vehicle computing device, a request to authenticate the installed OTA software update, the installed OTA software update having an associated second checksum value; sending, via the vehicle computing device, a signal to the secure server representing the second checksum value to be compared, by the secure server, with the first checksum value; receiving, with the vehicle computing device, a signal from the secure server indicating if the compared first and second checksum values match or do not match; determining, with the vehicle computing device, the installed OTA software update is authenticated if the received signal indicates the compared first and second checksum values match; and determining, with the vehicle computing device, the installed OTA software update authentication is failed if the received signal indicates the compared first and second checksum values do not match.

In addition to the foregoing, the described method may include one or more of the following features: rolling back, with the vehicle computing device, the installed OTA software update to a previous version of the OTA software update when the compared first and second checksum values do not match; receiving and reinstalling, with the vehicle computing device, the OTA software update stored in the secure server when the compared first and second checksum values do not match; providing, with the vehicle computing device, a vehicle user with an option to authenticate the installed OTA software update; wherein the received request to authenticate the installed software is received from the vehicle user via the provided option; wherein the option to authenticate the installed OTA software update is displayed on a vehicle display; and wherein the option to authenticate the installed OTA software update is displayed on a portable electronic device associated with the vehicle user.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a diagram of an example over-the-air (OTA) update system for a vehicle, in accordance with the principles of the present application;

FIG. 2 is a functional block diagram of an example vehicle computing device of the system of FIG. 1, in accordance with the principles of the present application;

FIG. 3 is a diagram illustrating an example data flow of the OTA update system shown in FIG. 1, in accordance with the principles of the present application; and

FIG. 4 is a flow diagram of an example OTA update authentication method, in accordance with the principles of the present application.

### DETAILED DESCRIPTION

As previously discussed, vehicles equipped with infotainment or multimedia systems often require over-the-air (OTA) software updates, also referred to as firmware-over-the-air (FOTA) or software-over-the-air (SOTA). However, unsecured software updates may be compromised by unauthorized users (e.g., hackers). While it is possible to perform authentication checks on the software update package prior to the OTA updates in the vehicle, the authentication check is no longer available following the in-vehicle update. As such, if an unauthorized user successfully bypasses all authentication checks prior to OTA/FOTA/SOTA updates, it may not be possible to identify the security breach.

Accordingly, systems and methods are provided for authenticating OTA software updates for vehicle systems such an infotainment system. More specifically, the systems described herein include a verification mechanism to validate and verify the authenticity of OTA updates after the update is completed. Once the software update package is delivered OTA to the vehicle and installed, the user (e.g., driver) is alerted and prompted to check the authenticity of the software update package, for example, via an infotainment display, an instrument panel cluster display, or personal electronic device. If the user chooses to validate the OTA software update, the vehicle subsequently determines whether the installed update is secure (authenticated) or compromised (not authenticated). If the OTA software update is identified as compromised, the user may be prompted to roll back to a previous software version or a new OTA software update may be installed.

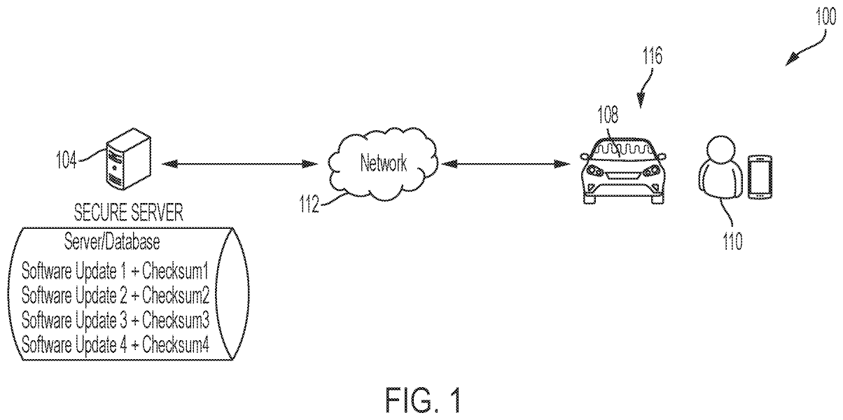

With reference now to FIG. 1, a diagram of an example vehicle OTA software update and authentication system 100 is illustrated in accordance with the principles of the present disclosure. In the example embodiment, the vehicle OTA software update and authentication system 100 may be a computing system that includes a secure backend server 104 configured to communicate with a vehicle computing device 108 via a network 112. The secure backend server 104 may include one or more secure servers, which for example, are owned and operated by a particular vehicle original equipment manufacturer (OEM) and are only accessible to authorized users, such as a particular type or brand of vehicle.

In the example embodiment, the vehicle computing device 108 is an infotainment or multimedia system for a vehicle 116, but it will be appreciated that vehicle computing device 108 may be any suitable vehicle computing device configured to receive OTA software updates. The network 112 can be any suitable communication network including, for example, a satellite network, a cellular network (3G, 4G LTE, 5G, etc.), a computing network (local area network, the internet, etc.), or some combination thereof.

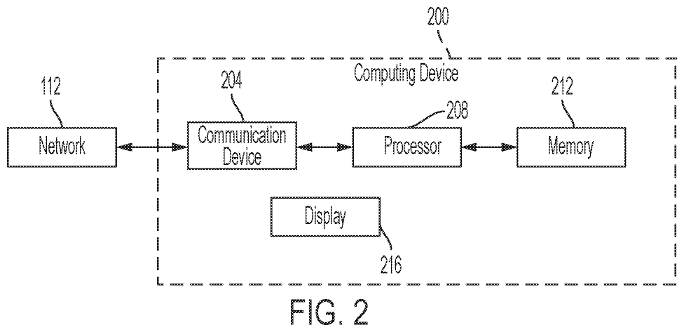

Referring now to FIG. 2, a functional block diagram of an example computing device 200 is illustrated. The computing device 200 can represent the configuration of the vehicle computing device 108, such as an infotainment or multimedia system for vehicle 116, as well as the backend server 104 and/or components of the communication network 112. In other configurations, computing device 200 may additionally or alternatively be a personal electronic device (e.g., smart phone, laptop computer, tablet computer, etc.) associated with the vehicle 116. In the example embodiment, the computing device 200 includes a communication device 204, a processor 208, a memory 212, and a display 216.

In the example embodiment, the communication device 204 (e.g., a wireless transceiver) is configured for communication via the network 112, and the processor 208 is configured to control operation of the computing device 200. The term “processor” as used herein can refer to both a single processor and two or more processors operating in a parallel or distributed architecture. The memory 212 can be any suitable storage medium (flash, hard disk, etc.) configured to store information at the computing device 200. In one implementation, the memory 212 is a non-transitory computer-readable storage medium configured to store instructions executable by the processor 208 to cause the computing device 200 to perform at least a portion of the disclosed techniques. The display 216 may be a touchscreen display configured to display one or more soft buttons (not shown) to facilitate performing at least a portion of the disclosed techniques. While not shown, it will be appreciated that computing device 200 can include other suitable components such as physical buttons, sensors, and the like. As further described below, the example vehicle OTA software update and authentication system 100 is configured to perform various techniques for validating and authenticating a vehicle OTA software update.

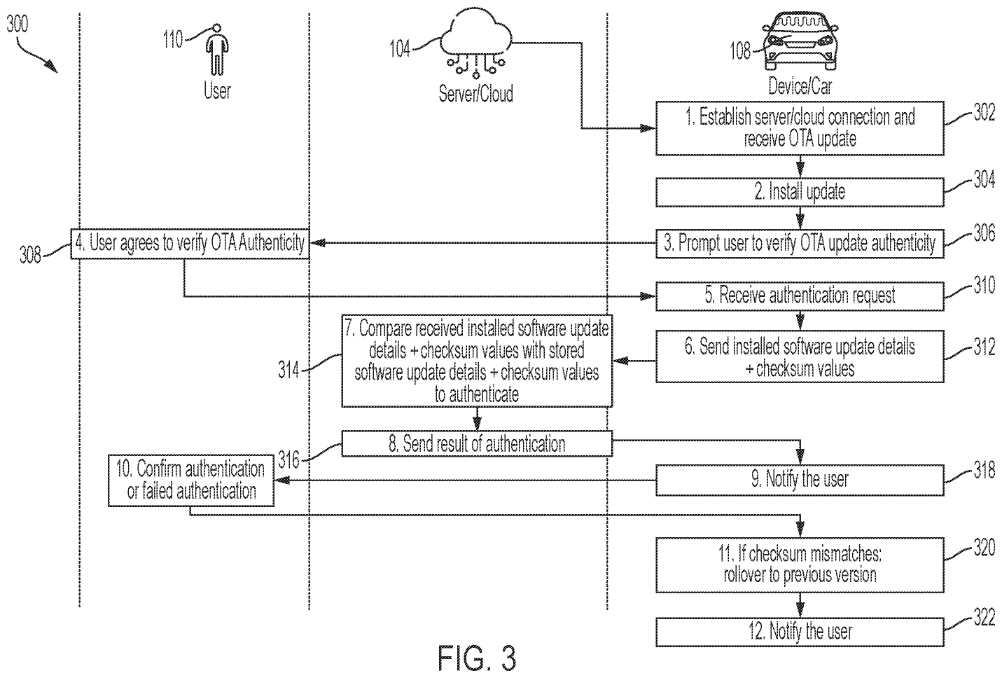

With reference now to FIG. 3, a diagram 300 of an example data flow of vehicle OTA software update and authentication system 100 is illustrated. In the example embodiment, the diagram 300 illustrates data flow between the secure backend server 104, the vehicle computing device 108 (e.g., infotainment system), and a user 110. In the example implementation, the secure backend server 104 is configured to store one or more Software Update Versions each having a Checksum value for that particular version. For example, the secure backend server 104 may store: Software Update v1+Checksum1, Software Update v2+Checksum2, Software Update v3+Checksum3, and Software Update v4+Checksum4 (see FIG. 1). In one example, the checksum corresponds to a number of digits in that particular Software Update Version which can be used to detect and identify differences in a compromised software update for authentication purposes, as described herein in more detail.

As shown in FIG. 3, the data flow begins at block 302 with backend server 104 sending an OTA/FOTA/SOTA software update (e.g., Software Update v3+Checksum3) to the vehicle computing device 108. At block 304, the vehicle computing device 108 then installs the received OTA software update. At block 306, the vehicle computing device 108 prompts user 110 to select if they want to authenticate the OTA software update, for example via touchscreen 216. At block 308, user 110 chooses to authenticate the OTA software update. At block 310, the vehicle computing device 108 receives the authentication request from user 110. At block 312, the vehicle computing device 108 determines which ECU bootloader OTA software update was the latest performed (e.g., v3), and sends a communication to the backend server 104 with information on the installed software update version and checksum value corresponding thereto.

At block 314, the backend server 104 receives the communication and compares the received installed software update version and checksum value with the stored software update version (bootloader+checksum). If the checksum values match, the installed software update is authenticated and secure. If the checksum values do not match, the installed software update is not authenticated (failed authentication). At block 316, the backend server 104 sends the results of the authentication analysis to the vehicle computing device 108.

At block 318, the vehicle computing device notifies user 110 of the result of the authentication, for example, via touchscreen 216. For example, the touchscreen 216 may direct the user to confirm the authentication results at block 320. If the checksum value for the installed update version does not match the checksum value for the stored update version, the installed software update is potentially compromised and the authentication is failed. Accordingly, at block 322, in response to the failed authentication, the vehicle computing device 108 subsequently reinstalls the OTA software update version or rolls back the software update to the previous software update (e.g., Software Update v2+Checksum2). At step 322, the vehicle computing device 108 may then notify the user 110 of the rollback/reinstallation.

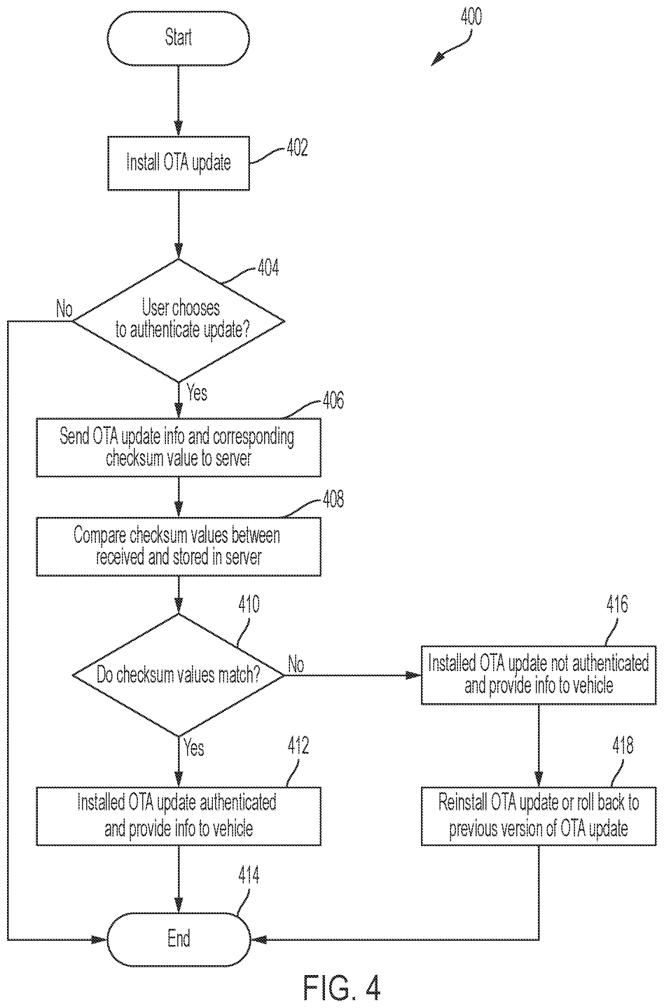

With reference now to FIG. 4, an example computer-implemented method 400 for authenticating a vehicle OTA/FOTA/SOTA update is provided. The method begins at step 402, where the vehicle computing device 108 receives and installs the vehicle OTA software update. At step 404, the vehicle computing device 108 prompts a user to authenticate the installed OTA software update. For example, the prompt may include a message asking the user whether they want to authenticate the recently installed OTA software update along with ‘YES’ and ‘NO’ soft-buttons displayed on touchscreen 216. If the user declines the authentication request, control proceeds to step 414 and ends.

If the user confirms the authentication request, control proceeds to step 406 and vehicle computing device 108 sends a signal over network 112 to the backend server 104 indicating the version and checksum value of the installed OTA software update to be authenticated. At step 408, the backend server 104 compares the received version and checksum value from step 406 with the version and checksum value of the software update that is stored in the backend server 104. At step 410, the backend server 104 determines if the installed software version and checksum value match the stored software version and check sum value. If the installed software version and checksum value match the stored software version and check sum value, control proceeds to step 412. If the installed software version and checksum value do not match the stored software version and check sum value, control proceeds to step 416.

At step 412, if the installed and stored checksums match, backend server 104 determines the installed vehicle OTA software update is authenticated, and control ends at step 414. At step 416, if the installed and stored checksums do not match, backend server 104 determines the installed vehicle OTA software update is not authenticated and potentially compromised. The backend server 104 then sends a signal over network 112 to the vehicle computing device 108 indicating the installed OTA software update has failed authentication. At step 418, the vehicle computing device 108 then reinstalls the latest OTA software update version or rolls back to the previously installed (and authenticated) OTA software update version. Control then ends at step 412.

Described herein are systems and methods to authenticate an OTA software update installed in a vehicle or device thereof. Rather than authenticate the OTA software update before installation, leaving the software update vulnerable to subsequent manipulation, the system first installs the OTA software update. The system then prompts a user to initiate/request an authentication procedure for the installed OTA software update. Once initiated, information about the installed OTA software update, including version and an associated checksum value, are sent to a secure server where the original OTA software update is stored. The server compares the checksum value of the installed update with a checksum value of the stored update to determine if the installed update has been manipulated. If the compared checksum values match, the installed OTA software update is authenticated as secure. If the compared checksum values do not match, the installed OTA software update is not authenticated and is potentially compromised. If the authentication fails (checksums do not match), the installed software update may be rolled back to a previous software version, or a new OTA software update may be installed.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A vehicle with an over-the-air (OTA) software update and authentication system, comprising:
a vehicle computing device, including one or more processors, a communication device for communication with a secure server via a network, and a non-transitory computer-readable storage medium having a plurality of instructions stored thereon, which, when executed by the one or more processors, cause the one or more processors to perform operations comprising:
receive and install an OTA software update stored in the secure server, the stored OTA software update having an associated first checksum value;
receive a request to authenticate the installed OTA software update, the installed OTA software update having an associated second checksum value;
send a signal to the secure server representing the second checksum value to be compared, by one or more processors of the secure server, with the first checksum value;
receive, from the secure server, a signal indicating if the compared first and second checksum values match or do not match;
determining the installed OTA software update is authenticated if the received signal indicates the compared first and second checksum values match; and
determining the installed OTA software update authentication is failed if the received signal indicates the compared first and second checksum values do not match.

2. The vehicle of claim 1, wherein when the compared first and second checksum values do not match, the computing device rolls back the installed OTA software update to a previous version of the OTA software update.

3. The vehicle of claim 1, wherein when the compared first and second checksum values do not match, the vehicle computing device receives and reinstalls the OTA software update stored in the secure server.

4. The vehicle of claim 1, wherein after installing the OTA software update, the computing device provides a vehicle user with an option to authenticate the installed OTA software update.

5. The vehicle of claim 4, wherein the received request to authenticate the installed OTA software update is received from the vehicle user via the provided option.

6. The vehicle of claim 4, wherein the option to authenticate the installed OTA software update is displayed on a vehicle display.

7. The vehicle of claim 4, wherein the option to authenticate the installed OTA software update is displayed on a portable electronic device associated with the vehicle user.

8. A computer-implemented method for authenticating an over-the-air (OTA) software update for a vehicle, comprising:
receiving, at a vehicle computing device having one or more processors, an OTA software update stored in a secure server, the stored OTA software update having an associated first checksum value;
installing, with the vehicle computing device, the received OTA software update;
receiving, via the vehicle computing device, a request to authenticate the installed OTA software update, the installed OTA software update having an associated second checksum value;
sending, via the vehicle computing device, a signal to the secure server representing the second checksum value to be compared, by the secure server, with the first checksum value;
receiving, with the vehicle computing device, a signal from the secure server indicating if the compared first and second checksum values match or do not match;
determining, with the vehicle computing device, the installed OTA software update is authenticated if the received signal indicates the compared first and second checksum values match; and
determining, with the vehicle computing device, the installed OTA software update authentication is failed if the received signal indicates the compared first and second checksum values do not match.

9. The computer-implemented method of claim 8, further comprising rolling back, with the vehicle computing device, the installed OTA software update to a previous version of the OTA software update when the compared first and second checksum values do not match.

10. The computer-implemented method of claim 8, further comprising receiving and reinstalling, with the vehicle computing device, the OTA software update stored in the secure server when the compared first and second checksum values do not match.

11. The computer-implemented method of claim 8, further comprising providing, with the vehicle computing device, a vehicle user with an option to authenticate the installed OTA software update.

12. The computer-implemented method of claim 11, wherein the received request to authenticate the installed software is received from the vehicle user via the provided option.

13. The computer-implemented method of claim 11, wherein the option to authenticate the installed OTA software update is displayed on a vehicle display.

14. The computer-implemented method of claim 11, wherein the option to authenticate the installed OTA software update is displayed on a portable electronic device associated with the vehicle user.
